(19) United States
(12) Patent Application Publication
(10) Pub. No.: US 2003/0144399 A1
(43) Pub. Date: Jul. 31, 2003

(54) Polymeric stabilizer for pigment dispersions

(76) Inventors: Bruce L. Matta, Emmaus, PA (US); Ronald W. Broadbent, Horsham, PA (US); Grannis S. Johnson, Durham, NC (US); Michael S. Wiggins, Lansdale, PA (US)

Correspondence Address: COGNIS CORPORATION, 2500 RENAISSANCE BLVD., SUITE 200, GULPH MILLS, PA, 19406

(21) Appl. No.: 10/262,786

(22) Filed: Oct. 2, 2002

Related U.S. Application Data
(60) Provisional application No. 60/339,893, filed on Oct. 31, 2001.

(51) Int. Cl. C08K 3/30

(52) U.S. Cl. 524/419; 524/432; 524/435; 524/556; 524/558; 524/425

(57) ABSTRACT

A water soluble copolymer useful as an inorganic pigment dispersant is comprised of a polymerized (1) monomer which is an ethylenically unsaturated organic phosphate or phosphonate and (2) an ethylenically unsaturated carboxylated monomer, wherein the amount of the ethylenically unsaturated carboxylated monomer is sufficient to permit the copolymer to associate with an inorganic pigment in an aqueous medium in a manner which disperses the inorganic pigment in the aqueous medium to form a stable aqueous dispersion of the inorganic pigment. The pigment dispersants according to the invention are particularly useful for dispersing concentrated ZnO slurries having a ZnO content of up to about 70% and in slurries containing ZnO in the presence of TiO2.

### CROSS-REFERENCE TO RELATED APPLICATIONS

This application claims the benefit of copending provisional application serial No. 60/339,893, filed on Oct. 31, 2001, the entire contents of which are incorporated herein by reference.

### FIELD OF THE INVENTION

The present invention relates to water soluble copolymers useful in stabilizing pigment dispersions and methods of preparing such polymers, methods of preparing pigment dispersions useful in the manufacture of latex paints, and latex paints prepared therewith.

### BACKGROUND OF THE INVENTION

Paint coatings are protective surface coatings applied to substrates and cured to form dry continuous films for decorative purposes as well as to protect the substrate. Consumer latex paint coatings are air-drying aqueous coatings applied primarily to architectural interior or exterior surfaces, where the coatings are sufficiently fluid to flow out, form a continuous paint film, and then dry at ambient temperatures to form continuous films.

A paint coating is ordinarily comprised of an organic polymeric binder, pigments, and various paint additives. Water is used as the vehicle in water-borne coatings. In dried paint films, the polymeric binder functions as a binder for the pigments and provides adhesion of the dried paint film to the substrate. The pigments may be organic or inorganic and functionally contribute to opacity and color in addition to durability and hardness.

The manufacture of paint coatings involves the preparation of a grind paste by mixing of component materials, grinding of pigment in the presence of a pigment dispersant, mixing the pigment grind with the polymeric binder, and thinning to commercial standards. High speed dispersers or dissolvers are used in the grinding step to disperse the pigments into the vehicle with use of dispersants.

Polyacrylic acid in its neutralized form has been used to prepare aqueous pigment dispersions, particularly dispersions of TiO₂. Polyacrylic acid disperses the pigment well into the latex paint into which the pigment dispersion is incorporated. However, polyacrylic acid also tends to contribute to water sensitivity of the dried paint coating. For example, an exterior paint coating is more susceptible to water damage as a result of precipitation and an interior paint coating may be damaged when scrubbed with aqueous liquids, e.g. soap and water. A pigment dispersant with a reduced contribution to the water sensitivity of the dried paint coating is therefore desirable.

Reactive pigments, such as ZnO are a common additive to latex paint. The reactive pigments can react with other ingredients in the paint formulation creating the undesired side effect of destabilization of the system resulting in a tendency to increase in viscosity and gelling of the paint. This is particularly noticeable in systems that contain both TiO₂ and ZnO. Dispersants are added to the paint formulations to stabilize the reactive pigments in the paint formulations. In aqueous systems, anionic dispersants are preferentially adsorbed onto the pigment. This imparts an ionic charge that prevents pigment flocculation. Carboxylated functional groups grafted onto the backbone of the dispersement polymer will impart anionic activity and create electrostatic repulsive forces necessary to ensure stability and efficiency. It is therefore desirable to have a dispersant that will stabilize reactive pigments that does not contribute to the water sensitivity of the dried film.

### SUMMARY OF THE INVENTION

This invention relates to a water soluble copolymer useful as an inorganic pigment dispersant, the copolymer comprised of a polymerized (1) organic phosphate or phosphonated ethylenically unsaturated monomer and (2) an ethylenically unsaturated carboxylated monomer, wherein the amount of the ethylenically unsaturated carboxylated monomer is sufficient to permit the polymer to associate with an inorganic pigment in an aqueous medium in a manner which disperses the inorganic pigment in the aqueous medium to form a stable aqueous dispersion of the inorganic pigment. A copolymer having as one of its components an organic phosphate or phosphonate, properly chosen, stabilizes the inorganic pigments in solution and provides enough hydrophobicity to improve the water resistance of the applied film. The pigment dispersants according to the invention are particularly useful for dispersing concentrated ZnO slurries having a ZnO content of up to about 70%.

This invention also relates to a method of stabilizing an inorganic pigment dispersion useful in the preparation of latex paints and to the stable dispersion made thereby, said method comprising dispersing an inorganic pigment in an aqueous medium comprising the dispersing polymer of the present invention.

This invention further relates to a process of preparing a water soluble polymer useful as an inorganic pigment dispersant, the process comprising dissolving monomers comprising (1) an organic phosphate or phosphonated ethylenically unsaturated monomer and (2) an ethylenically unsaturated carboxylated monomer in a solvent consisting essentially of water and a water-miscible organic solvent, and polymerizing the monomers in the solution to produce the polymer of the present invention. Both random and block copolymers are within the scope of the formula.

This invention also relates to a method of preparing an inorganic pigment dispersion useful in the preparation of latex paints, said method comprising dispersing an inorganic pigment in an aqueous medium comprising the dispersing copolymer of the present invention.

This invention also relates to inorganic pigment and organic dispersions comprising pigments and a dispersing polymer as described above in an aqueous medium.

This invention also relates to latex paints comprising the pigment dispersion composition of this invention and to a method of coating a substrate comprising contacting a surface of a substrate with a composition comprising a latex paint binder and the inorganic pigment dispersion of this invention and drying the surface to form a film of the composition in contact with the surface.

In typical embodiments, the monomers consist essentially of one or more of the organic phosphate or phosphonated monomers in an amount of from about 1% to about 60% by weight, and one or more of the carboxylated monomers in an amount of from about 40% to about 99% by weight based on the total weight of the polymer. The polymer typically has a molecular weight (e.g. weight average) of from about 1,000 to about 50,000.

Currently, commercially available dispersants used within the Coatings Industry do not exhibit “excellent” ZnO stability without compromising the water resistance of the final dried film. Viscosity and pH increases can occur over time in some formulations that do not contain sufficient levels of auxiliary surfactant and/or inorganic phosphates. Inorganic phosphates are known for their ability to stabilize ZnO in the presence of titanium oxide. Furthermore, inorganic phosphate presence within formulations tends to impart water sensitivity. The organic phosphate or phosphonate polymers of the present invention are particularly useful in stabilizing ZnO pigments in the presence of TiO2. The organic phosphate or phosphonated monomers, properly chosen will impart stability to the dispersion containing the reactive pigments without contributing to the water sensitivity of the dried film. Prior to the present invention, there have been no known dispersants that will disperse a concentrated ZnO slurry having a ZnO content of up to about 70%.

### DETAILED DESCRIPTION OF THE INVENTION

Except in the claims and the operating examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred, however. Also, throughout the description, unless expressly stated to the contrary: percent, “parts of”, and ratio values are by weight or mass; the term “polymer” includes “oligomer”, “copolymer”, “terpolymer” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ within the composition by chemical reaction(s) noted in the specification between one or more newly added constituents and one or more constituents already present in the composition when the other constituents are added, and does not necessarily preclude unspecified chemical interactions among the constituents of a mixture once mixed; specification of constituents in ionic form additionally implies the presence of sufficient counterions to produce electrical neutrality for the composition as a whole and for any substance added to the composition; any counterions thus implicitly specified preferably are selected from among other constituents explicitly specified in ionic form, to the extent possible; otherwise such counterions may be freely selected, except for avoiding counterions that act adversely to an object of the invention.

In certain aspects, this invention relates to novel polymers and to a method of making such polymers. In other aspects, this invention also relates to the use of the novel polymers to disperse an inorganic pigment in an aqueous medium and to the resulting dispersions. It has surprisingly been discovered that the organic phosphate or phosphonate polymers of the present invention are particularly useful in stabilizing ZnO pigments slurries, especially pigment slurries having a ZnO content of up to about 70% and in slurries containing ZnO in the presence of TiO2. In still other aspects, this invention also relates to latex paint compositions comprised of a latex paint binder and an inorganic pigment dispersion of this invention and to a method of coating a substrate which employs such latex paint compositions.

The inorganic pigment dispersant of this invention can be generally characterized as a carboxylated copolymer, i.e. a copolymer having structural units obtained by the polymerization of at least two different monomers via addition polymerization of the carbon-carbon double bonds which are also referred to as ethylenic unsaturation. When polymerized, these monomers become the structural units of the resulting copolymers according to the invention. The copolymers according to the invention are made by polymerizing: (1) an unsaturated organophosphorus compound selected from the group consisting of a phosphated monomer, a phosphonated monomer or a combination thereof and, (2) a carboxylated monomer. These copolymers will have carboxylate and phosphate and/or phosphonate functionalities pendant off the backbone of the copolymer. The acid value of the polymer of the present invention is greater than about 300 mg KOH/g, preferably from about 300 to 700 and even more preferably from about 350 to about 600.

The phosphated monomers that can be used to make the copolymers according to the invention are ethylenically unsaturated phosphated compounds of the formula I

R¹OR²OR³O—PO (I)

wherein each of R¹, R², and R³ is independently hydrogen or CH₂═CR⁴—CO—(OX)_{y}— wherein R⁴ is hydrogen or methyl; X is an alkylene group having from 2 to 4 carbon atoms and y is an integer of from 1 to 10 with the proviso that at least one of R¹, R², and R³ is CH₂═CR⁴—CO—(OX)_{y}—. Typical examples of compounds of the formula I include, but are not limited to, phosphoxyhexa(oxypropylene) mono-, di- and tri-methacrylate, phosphoxydodeca(oxypropylene) mono-, di- and tri-methacrylate, phosphoxyhexa(oxyethylene) mono-, di- and tri-methacrylate, phosphoxydodeca(oxyethylene) mono-, di- and tri-methacrylate, phosphoxyhexa(oxypropylene) mono-, di- and tri-acrylate, phosphoxydodeca(oxypropylene) mono-, di- and tri-acrylate, phosphoxyhexa(oxyethylene) mono-, di- and tri-acrylate, phosphoxydodeca(oxyethylene) mono-, di- and tri-acrylate and the like. These compounds are described in U.S. Pat. No. 5,151,125, the entire contents of which are herein incorporated by reference.

The phosphonated monomers that can be used to make the copolymers according to the invention are ethylenically unsaturated phosphated compounds of the formula II

(R⁶O)(R⁷O)R⁵—PO (II)

wherein R⁵ is a vinyl or substituted vinyl and each of R⁶ and R⁷ is independently hydrogen or a C₁₋₁₈ alkyl group with the proviso that at least one of R⁶ or R⁷ is hydrogen. Examples of R⁵ include, but are not limited to, CH₂═CH—, CH₂═CHCH₂—, C₆H₅CH═CH—, CH₂═C(CH₃), (CH₃)₃CCH₂C(CH₃)═CH—, CH₂═C(C₆H₅)—, C₆H₅C(CH₃)═CH—, CH₂═CCl—, ClCH═CH—, Cl₂C═CH— and the like In addition, Beta, gamma-unsaturated phosphonic acids are within the scope of the invention, such as CH₃C═CHC(CH₃)₂P(O)OH.

Additional examples of phosphonate monomers can be found in “Organophosphorus Monomers and Polymers” by E. L. Gefter (in Russian), translated by G. M. Kosolapoff, edited by L. Jacolev, Associated Technical Services, Inc., Chap. 1, pages 3-9, 1962.

The carboxylated functional group in the polymer is supplied by ethylenically unsaturated carboxylated monomers and gives the polymer an anionic charge and ability to stabilize the inorganic pigments. Examples of ethylenically unsaturated carboxylated monomers which may also be useful as comonomers to prepare the polymer of the invention include acrylic acid, beta-acryloxypropionic acid and higher oligomers of acrylic acid and mixtures thereof, methacrylic acid, itaconic acid, aconitic acid, crotonic acid, citraconic acid, maleic acid, fumaric acid, alpha-chloroacrylic acid, cinnamic acid, mesaconic acid and mixtures thereof. Preferred examples are acrylic acid and methacrylic acid. Such acids are described in “Acrylic and Methacrylic Acid Polymers”, Encyclopedia of Polymer Science and Engineering, vol. 1, pp. 211-234 (John Wiley & Sons, Inc., N.Y., N.Y., 1985), the disclosure of which is incorporated herein by reference. Further examples of carboxylated monomers that may be useful include the partial esters of unsaturated aliphatic dicarboxylic acids and particularly the alkyl half esters of such acids. Examples of such partial esters are the alkyl half esters of itaconic acid, fumaric acid and maleic acid wherein the alkyl group contains 1 to 6 carbon atoms. Representative members of this group of compounds include methyl acid itaconic, butyl acid itaconic, ethyl acid fumarate, butyl acid fumarate, and methyl acid maleate. These carboxylated monomers generally have greater molecular bulk than the preferred monomer, acrylic acid, and thus, may have less hydrophilic character than the preferred monomer, acrylic acid. The use of such acid functional partial esters as the acid monomer may reduce the water sensitivity.

A hydrophobic monomer which is an ethylenically unsaturated aromatic compound can also be added to the polymer to improve the water resistance of the dried film. Examples of the ethylenically unsaturated aromatic compounds include, but are not limited to, 2-phenoxyethylacrylate, monovinyl aromatic hydrocarbons containing from 8 to 12 carbon atoms and halogenated derivatives thereof having halo-substituted aromatic moieties. Specific examples include but are not limited to styrene, alpha-methylstyrene, vinyl toluene, meta-methylstyrene, para-methylstyrene, para-ethylstyrene, para-n-propylstyrene, para-isopropylstyrene, para-tert-butylstyrene, ortho-chlorostyrene, para-chlorostyrene, alpha-methyl-meta-methylstyrene, alpha-methyl-para-methylstyrene, tert-butyl styrene, alpha-methyl-ortho-chlorostyrene, and alpha-methyl-para-chlorostyrene. Certain vinyl aromatic compounds are discussed in “Styrene Polymers”, Encyclopedia of Polymer Science and Engineering, Vol. 16, pp. 1-21 (John Wiley & Sons, Inc., N.Y., N.Y., 1989), the disclosure of which is incorporated by reference herein.

Typically, the polymer will contain from about 1% to about 60% by weight of the phosphate or phosphonate monomeric unit, preferably from about 10% to about 50% based on the total weight of the polymer. The amount of the ethylenically unsaturated carboxylated monomeric unit will typically be from about 40% to about 99% by weight of the polymer, more typically from about 50% to about 90% based on the total weight of the polymer. However, the precise characteristics desired of the aqueous pigment dispersion and the latex paint prepared therefrom will influence the determination of what is an optimal amount of the phosphate or phosphonate monomer and the ethylenically unsaturated carboxylated monomer.

While the preferred dispersing polymers, based on acrylic acid and/or methacrylic acid as the carboxylated monomer, other monoethylenically unsaturated polymerizable monomers are useful as comonomers with the phosphated or phosphonated and carboxylated monomers and may be useful in preparing the polymers of this invention. The amount of other monoethylenically unsaturated polymerizable monomers will optionally be from about 10% to about 60% by weight based on the total weight of the polymer, if used in the polymer. Examples of these other monoethylenically unsaturated monomers include but are not limited to the vinylidene halides, vinyl halides, acrylonitrile, methacrylonitrile, vinyl esters such as vinyl formate, vinyl acetate and vinyl propionate, and mixtures of ethylene and such vinyl esters, acrylic and methacrylic acid esters of alcohol ethers such as diethylene glycol monoethyl or monobutyl ether methacrylate, acrylic and methacrylic esters of monoalcohols such as butyl acrylate and hexyl acrylate, C₁-C₁₀ alkyl esters of beta-acryloxypropionic acid and higher oligomers of acrylic acid, mixtures of ethylene and other alkylolefins such as propylene, butylene, pentene and the like, vinyl ethers such as methyl vinyl ether, ethyl vinyl ether, vinyl 2-methoxyethyl ether, vinyl 2-chloroethyl ether and the like, hydroxy functional vinyl monomers such as 2-hydroxyethyl methacrylate, 2-hydroxyethyl acrylate, 3-hydroxypropyl methacrylate, butanediol acrylate, 3-chloro-2-hydroxypropyl acrylate, 2-hydroxypropyl acrylate, and 2-hydroxypropyl methacrylate.

In addition to mono-ethylenically unsaturated carboxylated monomers, the monomers from which the polymer is prepared may also optionally be comprised of an ethylenically unsaturated monomer having at least two sites of ethylenic unsaturation, i.e. a di- or higher multi-ethylenically unsaturated monomer. Examples of multiethylenic monomers include alkenyl acrylates or methacrylates (e.g. allyl methacrylate), di-alkenyl arenes, particularly di-alkenyl benzenes (e.g. divinyl benzene), di-alkenyl ethers (e.g. ethylene glycol di-allyl ether and pentaerythritol di-allyl ether), di-acrylamides (e.g. methylene-bis-acrylamide, trimethylene-bis-acrylamide, hexamethylene-bis-acrylamide, N,N′diacryloylpiperazine, m-phenylene-bis-acrylamide, and p-phenylene-bisacrylamide), di- or higher multi-acrylates (e.g. diethylene glycol diacrylate, propylene glycol dimethacrylate, ethylene glycol dimethacrylate, polyethylene glycol diacrylate, bis(4-acryloxypolyethoxyphenyl)-propane, 1,3-butylene glycol dimethacrylate, 1,5-pentanediol diacrylate, neopentyl glycol diacrylate, 1,6-hexanediol diacrylate, and polypropylene glycol diacrylate, pentaerythritol triacrylate, trimethylolpropane triacrylate, trimethylolpropane trimethacrylate, pentaerythritol tetraacrylate, triethylene glycol, and dimethacrylate). Such multifunctional monomers may be useful as crosslinking agents to modifying the molecular weight of the polymer and improve the paint film's water resistant properties. The amount of the multiethylenic monomers, if used, will typically be from about 0.1% to about 10% by weight of total monomers, but the polymer should not be so highly crosslinked that it is rendered insoluble.

While it is thus conceivable that the polymer will contain monomeric units derived from monomers other than the phosphate or phosphonated monomer and the carboxylated monomer, in preferred embodiments, the polymer is prepared by solution polymerization of monomers comprising:

(a) from about 1% to about 60%, preferably from about 10% to about 50%, by weight based on the total weight of monomers, of an ethylenically unsaturated phosphate or phosphonate monomer,

(b) from about 40% to about 99%, preferably from about 50% to about 90%, by weight based on the total weight of monomers, of an ethylenically unsaturated carboxylated monomer having less than six carbon atoms, preferably acrylic acid and/or methacrylic acid, and optionally

(c) from about 10% to about 60% of a hydrophobic monomer based on the total weight of monomers.

In general, the polymer will have a molecular weight (e.g. weight average) of from about 500 to about 50,000, typically from about 2,000 to about 15,000. The acid value is greater than about 300, preferably from about 300 to about 700 and even more preferably from about 350 to about 600.

In the polymerization process of this invention, the monomers are dissolved in a solvent then polymerized in solution using either a thermal or redox initiator.

The polymerization solvent of this invention has two components, water and an organic solvent. The organic solvent must be miscible with water in the proportion in which the water is present in the solvent system. It should be noted that the identity and amounts of the monomers in the solution may affect the miscibility of the organic solvent and the water. The solvent is chosen and/or ratio of solvents based on the solubility of the monomers being used. Phosphated and phosphonated monomers require some of the more polar solvents, such as alcohols and ketones to solubilize because they are ionic. The organic solvent must not only be miscible with water, but miscible with the resulting solution as a whole. The relative amounts of the organic solvent and water in the solvent system must be selected so that the monomers dissolved therein remain miscible with the solution during the course of the polymerization reaction. Accordingly, by “water-miscible” it is meant that the organic solvent will not form a discrete second liquid phase in the reaction medium.

The organic solvent may also function as a chain transfer agent. Chain transfer is discussed in “Chain Transfer”, Encyclopedia of Polymer Science and Engineering, Vol. 3, pp. 288-290 (John Wiley & Sons, Inc., N.Y., N.Y., 1985), the disclosure of which is incorporated herein by reference. Chain transfer refers to the termination of a growing polymer chain and the start of a new one by a chain transfer agent. The chain transfer coefficients of solvents are available in the literature, e.g. J. Brandrup and E. H. Immergut, Polymer Handbook, (2d ed., John Wiley & Sons, Inc., N.Y., N.Y., 1975), the disclosure of which is incorporated herein by reference. Typically, the organic solvent will be an oxygenated hydrocarbon, for example an alcohol, ketone (e.g. acetone), or ester (e.g. ethyl acetate), typically having no more than about six (preferably no more than about three) carbon atoms per oxygen atom. Typically, the organic solvent will be a lower alkanol, e.g. a C₁-C₆, more typically a C₂-C₄ alkanol, e.g. isobutanol. The preferred organic solvent is isopropanol. The molecular weight of the product is affected by the solvents chosen. Solvents that act as chain transfer agents will keep the molecular weight lower. Water, isopropyl alcohol, as well as other alcohols and ketones will act as chain transfer agents.

The polymerization process may be a thermal or redox type; that is, free radicals may be generated solely by the thermal dissociation of an initiator species or a redox system may be used. A polymerization initiator of the free radical type, such as ammonium or potassium persulfate, may be used alone or as the oxidizing component of a redox system, which also includes a reducing component such as potassium metabisulfite, sodium thiosulfate or sodium formaldehyde sulfoxylate. The reducing component is frequently referred to as an accelerator. The initiator and accelerator, commonly referred to as catalyst, catalyst system or redox system, are typically used in proportion from about 0.01% to 10% or less each, based on the total monomer weight. Examples of redox catalyst systems include t-butyl hydroperoxide/sodium formaldehyde sulfoxylate/Fe(II), and ammonium persulfate/sodium bisulfite/sodium hydrosulfite/Fe(II). When using a thermal initiator the boiling point of the solvent is important. The polymerization temperature may be from room temperature to 90° C. (with isobutanol) or 80° C. (with isopropanol), or more if the reaction zone is pressurized to maintain the solvent as a liquid, and may be optimized for the catalyst system employed, as is conventional. The temperature of the reaction vessel during the polymerization may be controlled by cooling to remove heat generated by the polymerization reaction or by heating the reaction vessel.

Chain transfer agents and chain terminators including mercaptans, polymercaptans and polyhalogen compounds can be added in small quantities, from about 0.01% to about 3%, and preferably from about 0.1% to about 1% of the total monomer weight to control polymer molecular weight. Examples of chain transfer agents which may be used include but are not limited to dodecyl mercaptan, mercaptopropionic acid, long chain alkyl mercaptans such as t-dodecyl mercaptans, alcohols such as isopropanol, isobutanol, lauryl alcohol or t-octyl alcohol, carbon tetrachloride, tetrachloroethylene and trichlorobromoethane.

### Inorganic Pigment Dispersions

In one aspect, this invention relates to a method of preparing a pigment dispersion useful in the preparation of latex paints. The method in its broadest conception comprises dispersing a pigment in an aqueous medium further comprised of the water soluble dispersing polymer of the present invention. While the carboxylated monomer which forms part of the dispersing polymer will typically be in the free acid form during the solution polymerization, the aqueous medium in which the inorganic pigment is to be dispersed will typically have a neutral, or even alkaline, pH such that the monomeric unit derived from the carboxylated monomer will typically be in the form of a charged anion, e.g., carboxylate.

In one embodiment of the invention, a pigment dispersion comprises the water soluble dispersing polymer of the present invention dissolved in an aqueous solvent that has been neutralized. Examples of neutralization agents include but are not limited to ammonia, organic amine sodium hydroxide, potassium hydroxide and lithium hydroxide. The preferred neutralization agent is ammonia. Typically, the aqueous solvent will contain only ammonia to avoid any contribution to the volatile organic content of the pigment dispersion, but examples of suitable organic amines that can be used in place of, or with ammonia include primary, secondary, and tertiary amines which can act as a base to salt polymer. Specific examples of organic amines are the dialkyl aminoalkanols such as 2-(N,N-dimethylamino)ethanol and 2-(N,N-diethylamino)ethanol. Additional neutralizing agents are described in U.S. Pat. No. 5,104,922, the entire contents of which are herein incorporated by reference.

The neutralizing agent is present in the aqueous solution in an amount sufficient to solubilize the dispersing polymer. In general, the ammonia or organic amine or other neutralizing agent will be present in the aqueous solution in an amount sufficient to theoretically neutralize the acid groups of the polymer. The pH of the pigment dispersion will generally be greater than about 7 and preferably from about 7 to about 12. A large excess of organic amine should be avoided because retention of the organic amine in the dried paint coating may adversely affect the water resistance of the coating.

The amount of the carboxylated monomer used to prepare the dispersing polymer should be sufficient in relation to the amount of the organic phosphate or phosphonated monomer to yield a water soluble polymer that is sufficiently capable of associating with the inorganic pigment such that a stable pigment dispersion is formed. If the polymer is not sufficiently capable of associating with the inorganic pigment, observable precipitation of the pigment during the intended shelf life of the pigment dispersion or the latex paint prepared therewith may occur.

The pigment dispersion is typically made by first dissolving the dispersing polymer in water. One of the ingredients of the pigment dispersions of this invention is an inorganic pigment or colorant. The generic term pigment includes both colorant pigments and opacifying pigments. The term “colorant pigment” is specifically used in this specification to refer to both pigments and dyes which impart a distinct color (i.e. a hue as opposed to white (the absence of color) or black and/or shades of gray) to the composition.

The pigment of the dispersion may be a colorant pigment, i.e. the pigment will impart a color to the pigment dispersion, to a printing ink or latex paint prepared therefrom, and to the surface of a substrate printed with such a printing ink or latex paint. The colorant pigments useful in this invention will typically include, but are not limited to black, inorganic red, inorganic yellow, as well as violet, orange, green, and brown. Useful pigments include for instance ferrite yellow oxide, red iron oxides, ferric iron oxide brown (which is a blend of red, yellow, and black iron oxides), tan oxide (which is a similar blend), raw sienna and burnt sienna, raw and burnt umber, carbon black, lampblack.

The inorganic pigment will typically, however, be an opacifying pigment. For purposes of this invention, white opacifying pigments are not considered to be colorant pigments. Opacifying pigments are generally pigments having a refractive index of at least about 1.8. Typical white opacifying pigments include ZnO, rutile and anatase TiO2. Of particular interest to this invention are the reactive pigments which include, but are not limited to, ZnO, TiO2, calcium carbonate, barium sulfate, and zinc phosphate. The dispersions can further contain non-opacifying filler or extender pigments often referred to in the art as inerts and include clays, such as kaolinite clays, silica, talc, mica, barytes, calcium carbonate, and other conventional filler pigments. All filler or extender pigments have fairly low refractive indices and can be described generally as pigment other than opacifying pigment.

The pigment dispersions of this invention may be prepared as follows. The pigment is mixed with an aqueous solution of the dispersing polymer and, at a properly adjusted viscosity, dispersed thereinto. The dispersion may contain other ingredients, examples include but are not limited to: surfactants, organic solvents and filters. The process of dispersing causes agglomerates of the pigment particles to deagglomerate and the dispersing polymer causes the deagglomerated particles of pigment to be wetted with the aqueous solution. This wetting thus inhibits the reagglomeration of the pigment particles by preferential adsorption of the dispersant onto the pigment surface thereby insuring stabilization by either of the following two mechanisms: electrostatic repulsive forces or steric hindrance.

The pigment dispersion will typically be characterized as a slurry of the pigment in an aqueous medium which also contains the water soluble dispersing polymer. Typically, the weight ratio of inorganic pigment to aqueous medium is from about 1:1 to about 10:1, more typically from about 1.5:1 to about 5:1. The ratio of inorganic pigment to aqueous medium is based on which inorganic pigments are used, what other additives are in the grind, what viscosity is required during the grind. The dispersant polymer solids in the grind stage is from about 0.1% to about 10%, and preferably from about 0.5% to about 5% and more preferably from about 0.5% to about 1.5% of the total weight of inorganic pigment.

It has long been a problem in the industry that with aging, a pigment dispersion will settle and hard pack. It has surprisingly been found that the water soluble phosphated dispersion polymer of the invention provides aging stability to a pigment dispersion. A pigment dispersion made as described above, with the phosphated dispersing polymer of the present invention was tested against a non-phosphated dispersing polymer. The pigment dispersion made with the non-phosphated dispersant settled and hard parked when heat aging tests were conducted while the dispersion made with the phosphated dispersant of the invention was still liquid after the heat aging tests were conducted. Of particular interest are reactive pigments dispersions such as ZnO and CaCO₃, MgCO₃ and the like. Concentrated pigment dispersions show a particular problem of hard packing over time. Concentrated pigment dispersions made with the water soluble phosphated dispersant of the present invention have an extended shelf live as compared to dispersions made without a phosphated dispersant.

### Latex Paint Compositions

The invention includes latex paint compositions containing a dispersion of a water-insoluble polymer and a pigment dispersion of the present invention. The pigment dispersion being comprised of an inorganic pigment and the dispersing polymer of the present invention. The water-insoluble polymers may be any of the types conventionally utilized in latex paint compositions and include natural rubber latex ingredients and synthetic latices wherein the water-insoluble polymer is an emulsion polymer of mono- or poly-ethylenically unsaturated olefinic, vinyl or acrylic monomer types, including homopolymers and copolymers of such monomers. Latices and latex paints are discussed extensively in “Latices”, Encyclopedia of Polymer Science and Engineering, vol. 8, pp. 647-677 (John Wiley & Sons, Inc., N.Y., N.Y., 1987), and “Coatings”, Encyclopedia of Polymer Science and Engineering, vol. 3, pp. 615-675 (John Wiley & Sons, Inc., N.Y., N.Y., 1985), the disclosures of which are incorporated herein by reference.

Specifically, the water-insoluble emulsion polymer may include poly (vinyl acetate) and copolymers of vinyl acetate (preferably at least 50% by weight) with one or more of vinyl chloride, vinylidene chloride, styrene, vinyltoluene, acrylonitrile, methacrylonitrile, acrylamide, methacrylamide, maleic acid and esters thereof, or one or more of the acrylic and methacrylic acid esters mentioned in U.S. Pat. Nos. 2,795,564 and 3,356,627, which polymers are well-known as the film-forming component of aqueous base paints; homopolymers of C₂-C₄₀ alpha olefins such as ethylene, isobutylene, octene, nonene, and styrene, and the like; copolymers of one or more of these hydrocarbons with one or more esters, nitriles or amides of acrylic acid or of methacrylic acid or with vinyl esters, such as vinyl acetate and vinyl chloride, or with vinylidene chloride; and diene polymers, such as copolymers of butadiene with one or more of styrene, vinyl toluene, acrylonitrile, methacrylonitrile, and esters of acrylic acid or methacrylic acid. It is also quite common to include a small amount, such as 0.5 to 2.5% or more, of an acid monomer in the monomer mixture used for making the copolymers mentioned above by emulsion polymerization. Acids used include acrylic, methacrylic, itaconic, aconitic, citraconic, crotonic, maleic, fumaric, the dimer of methacrylic acid, and so on.

The vinyl acetate copolymers are well-known and include copolymers such as vinyl acetate/butyl acrylate/2-ethylhexyl acrylate, vinyl acetate/butyl maleate, vinyl acetate/ethylene, vinyl acetate/vinyl chloride/butyl acrylate and vinyl acetate/vinyl chloride/ethylene. Throughout this specification the term “acrylic polymer” means any polymer wherein at least 50% by weight is an acrylic or methacrylic acid or ester, including mixtures of such acids and esters individually and together. The term “vinyl acetate polymer” means any polymer containing at least 50% by weight of vinyl acetate.

The aqueous polymer dispersions may be prepared according to well-known procedures, using one or more emulsifiers of an anionic, cationic, or nonionic type. Mixtures of two or more emulsifiers regardless of type may be used, except that it is generally undesirable to mix a cationic with an anionic type in any appreciable amounts since they tend to neutralize each other. The amount of emulsifier may range from about 0.1 to 6% by weight or sometimes even more, based on the weight of the total monomer charge. When using a persulfate type of initiator, the addition of emulsifiers is often unnecessary. This omission or the use of only a small amount, e.g., less than about 0.5%, of emulsifier, may sometimes be desirable from a cost standpoint, and less sensitivity of the dried coating or impregnation to moisture, and hence less liability of the coated substrate to be affected by moisture.

The foregoing and other emulsion polymer systems which may be pigmented with the pigment dispersions of the invention are set forth in the extensive literature on the subject, such as U.S. Pat. Nos. 3,035,004; 2,795,564; 2,875,166; and 3,037,952, the entire contents of each patent is herein incorporated by reference.

The pigment dispersion may be added to polymer latex systems at any time during the preparation thereof, including during or after polymerization or copolymerization and by single or multiple additions. Normally, from about 0.1% to about 10%, preferably from about 1% to about 5% by weight of pigment dispersion on polymer latex solids is adequate to provide suitable levels of pigmenting. However, the amount may be higher or lower depending on the particular system, other additives present, and similar reasons understood by the formulator. The amount of pigment dispersion will be dependent upon the final end properties that the formulator seeks.

This invention also relates to a method of coating a substrate comprising contacting a surface of a substrate with a composition comprising a latex paint binder and an inorganic pigment dispersion of this invention and drying said surface to form a film of said polymer in contact with said surface. Methods of coating substrates, e.g. roll coating and spray coating, are described in “Coating Methods”, Encyclopedia of Polymer Science and Engineering, Vol. 3, pp. 553-575 (John Wiley & Sons, Inc., N.Y., N.Y., 1985), the disclosure of which is incorporated herein by reference.

The following examples will serve to further illustrate the invention, but should not be construed to limit the invention, unless expressly set forth in the appended claims. All parts, percentages, and ratios are by weight unless otherwise indicated in context.

### EXAMPLES

### Example 1

Polymer Preparation

Deionized water, 45.5 parts, was added to a four neck flask and heated to 80° C. A stirrer was attached to one neck, a receiver and condenser to a second neck, and two addition funnels with nitrogen sweep to the third. A thermometer was placed in the fourth. A monomer solution containing Monomer A, Monomer B, 6 parts deionized water, and 12 parts isopropanol was prepared. The monomer solution was stirred until uniform and placed into one of the addition funnels. An initiator solution containing 2.2 parts sodium persulfate and 9.3 parts deionized water was prepared. The initiator solution was stirred until uniform and placed in the second addition funnel.

Both the monomer and the initiator solutions were added so both were completely added in 2.5 hours. After both solutions were added, the mixture was stirred for 1 hour at 80° C.

The isopropanol solvent was removed by distillation while replacing with deionized water while maintaining approximately 25% solids. The mixture was cooled down and neutralized with a neutralizing agent i.e. NaOH, KOH, NH40H, etc.

The following samples were prepared using the above method.

| | | PARTS | | PARTS |
|---|---|---|---|---|
| SAMPLE | MONOMER A | A | MONOMER B | B |
| 194 | Methacrylic | 20 | Phosphated | 5 |
| | acid | | hydroxyethyl | |
| | | | acrylic | |
| | | | acrylate | |
| 136 | Methacrylic | 23 | Vinyl | 7.5 |
| | acid | | Phosphonic | |
| | | | acid | |
| 198 | Methacrylic | 17.5 | Phosphated | 2 |
| | acid | | hydroxyethyl | |
| | | | acrylic | |
| | | | acrylate | |
| 202 | Methacrylic | 15 | Phosphated | 10 |
| | acid | | hydroxyethyl | |
| | | | acrylic | |
| | | | acrylate | |
| 199 | Methacrylic | 22.5 | Phosphated | 2.5 |
| | acid | | hydroxyethyl | |
| | | | acrylic | |
| | | | acrylate | |
| 205 | Methacrylic | 15 | Phosphated | 10 |
| | acid | | hydroxyethyl | |
| | | | methacrylate | |
| 207 | Methacrylic | 20 | Phosphated | 5 |
| | acid | | hydroxyethyl | |
| | | | methacrylate | |
| 197 | Methacrylic | 12.5 + 6.25 | Phosphated | 6.25 |
| | acid + phenoxy | | hydroxyethyl | |
| | ethyl acrylate | | acrylic | |
| | | | acrylate | |

### Example 2

Pigment Dispersion and Paint Preparation

An amount of dispersing polymer solution sufficient to yield 1% polymer solids per total pigment solids in the pigment dispersion was mixed with the following ingredients.

A Grind was prepared with the following materials: 85 parts cellulose thickener (QP-4400®, 2.5% solids, Union Carbide Chemicals and Plastics Company, Inc., Danbury, Conn.), 62.5 parts deionized water, 2.5 parts non-ionic surfactant (TRITON® CF-10, Union Carbide Chemicals and Plastics Company, Inc, Danbury, Conn.), 1 part defoamer (NOPCO® NXZ, Cognis Corporation, Ambler, Pa.), 25 parts ethylene glycol, 237.5 parts TiO2 (TIPURE® R-960, DuPont, Wilmington, Del.), 25 parts ZnO, and 212.7 parts talc (NYTAL® 300, R. T. Vanderbilt Company, Inc., Norwalk, Conn.) and the experimental polymer dispersants as shown:

| | Parts of | |
|---|---|---|
| Example # of Dispersant | Dispersant | Description of dispersant |
| Polymer (% in water) | polymer added | polymer (% parts monomer) |
| TAMOL ® 850¹ (30%) | 15.8 | Rohm & Haas Co., |
| | | Philadelphia, PA |
| TAMOL ® 681¹ (35%) | 13.6 | Rohm & Haas Co., |
| | | Philadelphia, PA |
| 194A (29.4%) | 16.2 | 20 HEA-PO4/80 MAA Na; |
| | | Clear pinkish liquid |
| 194B (31.3%) | 15.2 | 20HEA-PO4/80MAA HN4; |
| | | Clear yellow liquid |
| 197A (30.0%) | 15.8 | 25 HEA-PO4/25 POE/50 |
| | | MAA Na; Hazy brown liquid |
| 197B (33.0%) | 14.4 | 25 HEA-PO4/25 POE/50 |
| | | MAA NH4; Hazy brown |
| | | liquid |
| 198A (30.0%) | 15.8 | 30 HEA-PO4/70 MAA Na; |
| | | Clear pinkish liquid |
| 198B (30.0%) | 15.8 | 30 HEA-PO4/70 MAA NH4; |
| | | Clear yellow liquid |
| 199A (33.0%) | 14.4 | 10 HEA-PO4/90 MAA Na; |
| | | Clear pinkish liquid |
| 199B (30.0%) | 15.8 | 10 HEA-PO4/90 MAA NH4; |
| | | Clear yellow liquid |
| 202 (30.0%) | 15.8 | 40 HEA-PO4/60 MAA Na + |
| | | NH4: Clear yellow liquid |

¹TAMOL ® 850 and TAMOL ® 681 will be referred to as T-850 and T-681 respectively.
BMA = butyl methacrylate
MAA Na = Sodium Salt of Methacrylic acid
MAA NH4 = Ammonium Salt of Methacrylic acid
HEA-PO4 = Phosphated hydroxyethyl acrylic acrylate
POE = Phenoxyethylacrylate

The mixture was ground for about 20 minutes using a high speed Dispermat CV model D 5226 until it reached a fineness-of-grind of 6+, the following was then added:

Letdown

The Letdown consisted of 421.6 parts acrylic latex binder (RHOPLEX® AC-2388, Rohm & Haas, Philadelphia, Pa.), 1 part defoamer (NOPCO® NXZ, Cognis Corporation, Ambler, Pa.), 9.3 parts tributyl phosphate, 34 parts propylene glycol, and 65.3 parts ammonia hydroxide (28%).

The pH of the resulting mixture was adjusted to a pH of 9.0 by adding a sufficient amount of 28% aqueous ammonium hydroxide. The test paints were allowed to equilibrate 24 hours prior to testing.

Test paints were applied to aluminum Q-Panels having a mill finish 3003 (0.025″×3″9″ dimension). Paints were applied 6 mils wet using a wet film applicator. Coated panels were then allowed to air dry horizontally for 24 hours. After 24 hours of film dry time, the panels were placed (coated side facing inside the chamber) on the QCT Weatherometer. This test method is a modified version of ASTM D 4585 with an internal chamber temperature of 100° F. Panels were rated hourly for the first eight hours with the final rating taken at hour 24. ASTM D714 is used to rate both frequency and size of visible blisters. Prior to QCT testing, gloss values were taken using a BYK Gardner Micro TRI glossmeter.

### Example 3

The eleven paints of example 2 were measured for their initial physical and application properties. The sample was then split into two aliquots, one of the aliquots was further split and 10 day mechanical stability testing was conducted. Physical & Application Properties were measured at 2 and 4 week intervals at ambient temperature and were also measured at 2 and 4 week intervals under 120° F. oven aging conditions. The KU (kreb unit to measure intermediate shear viscosity), ICI (high shear viscosity), FOG (fineness of grind measured in units of hegman), pH of the samples were measured before and after the 10 day mechanical stability. Water sensitivity testing on the formulations were done to determine the dried film's sensitivity. The physical properties measured were wt/gal, FOG, pH, KU, ICI. The application properties measured were 85° sheen, C/R is the contrast ratio where 100 means 100% hiding.

ZnO Compatible Dispersant Study
1% Dispersant Activities/Total Pigment Solids
Physical & Application Data

| | wt/gal | FOG | pH | KU | ICI | C/R | 85° Sheen | Note |
|---|---|---|---|---|---|---|---|---|
| T-850 Initial | 11.7 | 6 | 9.2 | 65 | 0.7 | 96 | 7 | |
| T-850 2 week AT | 11.7 | 6 | 9.1 | 68 | 0.7 | 96 | 7 | vscls |
| T-850 4 week AT | 11.8 | 6 | 9.1 | 68 | 0.8 | 96 | 7 | |
| T-850 2 week 120° F. | 11.7 | 6 | 9.0 | 71 | 0.7 | 96 | 7 | ok |
| T-850 4 week 120° F. | 11.8 | 6 | 9.1 | 71 | 0.7 | 96 | 7 | |
| 10 day Mech. Stab. | 12 | 6 | 9.2 | 76 | 1.2 | 96 | 6 | |
| T-681 Initial | 11.8 | 6 | 9.0 | 64 | 0.8 | 97 | 6 | |
| T-681 2 week AT | 11.8 | 6 | 8.9 | 71 | 0.7 | 97 | 6 | vscls |
| T-681 4 week AT | 11.8 | 6 | 8.9 | 81 | 0.8 | 97 | 6 | |
| T-681 2 week 120° F. | coagulated | | 8.8 | | | | | |
| T-681 4 week 120° F. | coagulated | | 8.8 | | | | | |
| 10 day Mech. Stab. | coagulated | | 8.9 | | | | | |
| 194A Initial | 11.8 | 6 | 9.0 | 67 | 0.6 | 96 | 7 | |
| 194A 2 week AT | 11.8 | 6 | 9.0 | 68 | 0.6 | 96 | 7 | ok |
| 194A 4 week AT | 11.8 | 6 | 9.0 | 68 | 0.7 | 96 | 7 | |
| 194A 2 week 120° F. | 11.8 | 6 | 9.0 | 74 | 0.6 | 96 | 7 | ok |
| 194A 4 week 120° F. | 11.8 | 6 | 9.0 | 75 | 0.7 | 96 | 7 | |
| 10 day Mech. Stab. | 12 | 6 | 9.0 | 86 | 1.4 | 96 | 6 | |
| 194B Initial | 11.5 | 6 | 9.1 | 67 | 0.8 | 96 | 6 | |
| 194B 2 week AT | 11.6 | 6 | 9.0 | 68 | 0.7 | 96 | 6 | ok |
| 194B 4 week AT | 11.6 | 6 | 9.0 | 69 | 0.7 | 96 | 6 | |
| 194B 2 week 120° F. | 11.6 | 6 | 9 | 74 | 0.8 | 96 | 7 | vscls |
| 194B 4 week 120° F. | 11.6 | 6 | 9 | 83 | 0.7 | 96 | 6 | vscls |
| 10 day Mech. Stab. | coagulated | | 9.0 | | | 96 | | |
| 197A Initial | 11.9 | 6 | 9.1 | 68 | 0.7 | 96 | 6 | |
| 197A 2 week AT | 11.8 | 6 | 9.1 | 70 | 0.7 | 96 | 7 | ok |
| 197A 4 week AT | 11.8 | 6 | 9.1 | 73 | 0.7 | 96 | 7 | |
| 197A 2 week 120° F. | 11.8 | 6 | 9.0 | 76 | 0.6 | 96 | 7 | ok |
| 197A 4 week 120° F. | 11.8 | 6 | 9.0 | 75 | 0.7 | 96 | 7 | vscls |
| 10 day Mech. Stab. | 12 | 6 | 9.1 | 76 | 1.2 | 96 | 6 | |
| 197B Initial | 11.8 | 6 | 9.1 | 68 | 0.6 | 96 | 6 | |
| 197B 2 week AT | 11.8 | 6 | 9.1 | 71 | 0.6 | 96 | 6 | vscls |
| 197B 4 week AT | 11.8 | 6 | 9.0 | 73 | 0.8 | 96 | 6 | |
| 197B 2 week 120° F. | 11.8 | 6 | 9.0 | 10 | 0.8 | 97 | 7 | slfloc |
| 197B 4 week 120° F. | coagulated | | 9 | 4 | | | | |
| 10 day Mech. Stab. | coagulated | | 9.1 | | | | | |
| 198B Initial | 11.6 | 6 | 9.1 | 64 | 0.7 | 96 | 6 | |
| 198B 2 week AT | 11.6 | 6 | 9.0 | 64 | 0.8 | 96 | 6 | vscls |
| 198B 4 week AT | 11.7 | 6 | 9.0 | 66 | 0.8 | 96 | 6 | |
| 198B 2 week 120° F. | 11.6 | 6 | 9.0 | 73 | 0.7 | 96 | 7 | scls |
| 198B 4 week 120° F. | 11.7 | 6 | 9.0 | 64 | 0.7 | 96 | 6 | slfloc |
| 10 day Mech. Stab. | coagulated | | 9.0 | | | | | |
| 199A Initial | 11.8 | 6 | 9.1 | 67 | 0.6 | 96 | 7 | |
| 199A 2 week AT | 11.8 | 6 | 9.1 | 69 | 0.6 | 96 | 7 | ok |
| 199A 4 week AT | 11.8 | 6 | 9.1 | 72 | 0.7 | 96 | 7 | |
| 199A 2 week 120° F. | 11.8 | 6 | 9.0 | 71 | 0.6 | 96 | 7 | scls |
| 199A 4 week 120° F. | 11.8 | 6 | 9.0 | 73 | 0.7 | 96 | 7 | |
| 10 day Mech. Stab. | 12 | 6 | 9.0 | 82 | 1.2 | 97 | 6 | |
| 199B Initial | 11.7 | 6 | 9.1 | 65 | 0.7 | 96 | 6 | |
| 199B 2 week AT | 11.8 | 6 | 9.0 | 65 | 0.6 | 96 | 6 | ok |
| 199B 4 week AT | 11.8 | 6 | 9.0 | 68 | 0.7 | 96 | 6 | vscls |
| 199B 2 week 120° F. | 11.8 | 6 | 9.0 | 73 | 0.7 | 96 | 7 | scls |
| 199B 4 week 120° F. | 11.8 | 6 | 9.0 | 67 | 0.7 | 96 | 6 | scls |
| 10 day Mech. Stab. | coagulated | | 9.0 | | | | | |
| 202 Initial | 11.8 | 6 | 9.0 | 67 | 0.7 | 96 | 6 | |
| 202 2 week AT | 11.8 | 6 | 9.0 | 74 | 0.7 | 96 | 7 | ok |
| 202 4 week AT | 11.8 | 6 | 9.0 | 76 | 0.8 | 96 | 7 | vscls |
| 202 2 week 120° F. | 11.8 | 6 | 8.9 | 82 | 0.7 | 96 | 7 | ok |
| 202 4 week 120° F. | 11.8 | 6 | 9.0 | 93 | 0.8 | 96 | 6 | vscls |
| 10 day Mech. Stab. | coagulated | | 9.0 | | | | | |

vscls = very slight clear liquid separation
scls = slight clear liquid separation
slfloc = slight flocculation but recoverable upon mild agitation

### Example 4

ZnO Compatible Dispersant Study: Water Resistant Test

Dispersant polymers from example 2.

| Example # of | | | | | | |
|---|---|---|---|---|---|---|
| Dispersant Polymer | WST | WST | TI | TI | QCT | QCT |
| (% in water) | 4 Hr FDT | 24 Hr FDT | 4 Hr FDT | 24 Hr FDT | 4 Hr FDT | 24 Hr FDT |
| T-850 (30% | 2D | 2D | 6M | 8F | 10 | 10 |
| T-681 (35%) | 8D | 8MD | 10 | 10 | 10 | 10 |
| 194A (29.4%) | 2D | 2D | 10 | 10 | 10 | 10 |
| 194B (31.3%) | 8M | 8M | 10 | 10 | 10 | 10 |
| 197A (30.0%) | 4MD | 4D | 6D | 8D | 10 | 10 |
| 197B (33.0%) | 6D | 8D | 10 | 10 | 10 | 10 |
| 198A (30.0%) | 2D | 2D | 8F | 10 | 10 | 10 |
| 198B (30.0%) | 2MD | 2D | 10 | 10 | 10 | 10 |
| 199A (33.0%) | 2D | 2D | 8F | 10 | 10 | 10 |
| 199B (30.0%) | 2MD | 4D | 10 | 10 | 10 | 10 |
| 202 (30.0%) | 2D | 6D | 10 | 10 | 10 | 10 |

For the water resistance tests:

WST=Water Spot Test. A paint film applied to glass and dried. A drop of Dl water is applied for to the film for X minutes. This is dried and the film is examined for defects/blisters/adhesion loss.

TI=Total Immersion. A paint film is applied to an aluminum panel and dried. The panel is immersed in ambient temp Dl water for X minutes. It is removed and dried and examined for defects/blisters/adhesion loss.

QCT=humidity chamber ASTM method. A paint film is applied to an aluminum panel and dried. It is then placed in a humidity cabinet for 24 hrs. When removed they were examined for defects/blisters/adhesion loss.

4 Hr FDT/24 Hr FDT=hrs. of film dry time at room temperature and humidity before testing.

Rating System: (ASTM D-714)

Numbers are blister sizes: 10=no blisters, 8=tiny<6<4<2=large, TAL=total adhesion loss (zero).

Letters are quantity of blisters: D=dense, MD=medium dense, F=few.

### Example 5

The following samples were prepared using the method of example 1.

| SAMPLE | MONOMER A | PARTS A | MONOMER B | PARTS B |
|---|---|---|---|---|
| Exp. 106B | Methacrylic Acid | 15 | Phosphated | 10 |
| | | | Hydroxyethyl | |
| | | | acrylic acrylate | |
| Exp. 136A | Methacrylic Acid | 22.5 | Phosphated | 2.5 |
| | | | Hydroxyethyl | |
| | | | acrylic acrylate | |

### Example 6

Pigment Dispersion and Paint Preparation

An amount of dispersing polymer solution sufficient to yield 1% polymer solids per total pigment solids in the pigment dispersion was mixed with the following ingredients.

A Grind was prepared with the following materials: 85 parts cellulose thickener (QP-4400®, 2.5% solids, Union Carbide Chemicals and Plastics Company, Inc., Danbury, Conn.), 62.5 parts deionized water, 2.5 parts non-ionic surfactant (TRITON® CF-1 0, Union Carbide Chemicals and Plastics Company, Inc., Danbury, Conn.), 1 part defoamer (NOPCO® NXZ, Cognis Corporation, Ambler, Pa.), 25 parts ethylene glycol, 237.5 parts TiO2 (TIPURE® R-960, DuPont, Wilmington, Del.), 25 parts ZnO, and 212.7 parts talc (NYTAL® 300, R. T. Vanderbilt Company, Inc., Norwalk, Conn.) and the experimental polymer dispersants as shown:

| | Parts of | |
|---|---|---|
| Example # of | Dispersant | |
| Dispersant Polymer | polymer | Description of dispersant polymer |
| (% in water) | added | (% parts monomer) |
| T-850 (30%) | 15.8 | Rohm & Haas Co., Philadelphia, PA |
| T-681 (35%) | 13.6 | Rohm & Haas Co., Philadelphia, PA |
| NOPCOSPERSE ® | 16.1 | Dispersant polymer, |
| 100 (29.5%) | | Cognis Corporation, Ambler, PA |
| Exp 106B (30%) | 15.8 | 20 POE/80 MAA NH4; Hazy, |
| | | dark brown liquid |
| Exp 106A (29.6%) | 13.6 | 20 POE/80 MAA Na; Hazy, |
| | | slightly green liquid |
| POLYACRYL ® | 11.3 | Polyacrylate Polymer- |
| B75-40K (42%) | | Polyacryl, Inc., Stamford, CT |
| ALCOSPERSE ® | 10.3 | Copolymer solution, |
| 177 (46%) | | Alco Chemical Corp., |
| | | Div. of National Starch & Chem., |
| | | Chattanooga, TN |

BMA = butyl methacrylate
MAA Na = Sodium Salt of Methacrylic acid
MAA NH4 = Ammonium Salt of Methacrylic acid
POE = Phenoxyethylacrylate

The mixture was ground for about 20 minutes using a high speed Dispermat CV model D 5226 until it reached a fineness-of-grind of 6+, the following was then added:

Letdown

The Letdown consisted of 421.6 parts acrylic latex binder (RHOPLEX® AC-2388, Rohm & Haas, Philadelphia, Pa.), 1 part defoamer (NOPCO® NXZ, Cognis Corporation, Ambler, Pa.), 9.3 parts tributyl phosphate, 34 parts propylene glycol, and 65.3 parts water and ammonia hydroxide (28%).

The pH of the resulting mixture was adjusted to a pH of 9.0 by adding a sufficient amount of 28% aqueous ammonium hydroxide. The test paints were allowed to equilibrate 24 hours prior to testing.

Test paints were applied to aluminum Q-Panels having a mill finish 3003 (0.025″×3″×9″ dimension). Paints were applied 6 mils wet using a wet film applicator. Coated panels were then allowed to air dry horizontally for 24 hours. After 24 hours of film dry time, the panels were placed (coated side facing inside the chamber) on the QCT Weatherometer. This test method is a modified version of ASTM D 4585 with an internal chamber temperature of 100 F. Panels were rated hourly for the first eight hours with the final rating taken at hour 24. ASTM D714 is used to rate both frequency and size of visible blisters. Prior to QCT testing, gloss values were taken using a BYK Gardner Micro TRI glossmeter.

### Example 7

The seven paints of example 6 were measured for their initial physical and application properties. The sample was then split into two aliquots, one of the aliquots was further split and 10 day mechanical stability testing was conducted. Physical & Application Properties were measured at 2 and 4 week intervals at ambient temperature and were also measured at 2 and 4 week intervals under 120° F. oven aging conditions. The KU (kreb unit to measure intermediate shear viscosity), ICI (high shear viscosity), FOG (fineness of grind measured in units of hegman), pH of the samples were measured before and after the 10 day mechanical stability. Water sensitivity testing on the formulations done to determine the dried film's sensitivity. The physical properties measured were wt/gal, FOG, pH, KU, ICI. The application properties measured were 85° sheen, C/R is the contrast ratio where 100 means 100% hiding.

ZnO Compatible Dispersant Study
1% Dispersant Actives/Total Pigment Solids
Physical & Application Data

| | wt/gal | FOG | pH | KU | ICI | C/R | 85° Sheen |
|---|---|---|---|---|---|---|---|
| T-850 Initial | 11.9 | 6 | 9.0 | 63 | 0.6 | 95 | 6.4 |
| T-850 2 week AT | 11.9 | 6 | 9.0 | 65 | 0.7 | 96 | 6.6 |
| T-850 4 week AT | 12 | 6 | 9.0 | 67 | 0.7 | 96 | 6.6 |
| T-850 2 week 120° F. | 12 | 6 | 8.9 | 72 | 0.9 | 96 | 6.5 |
| T-850 4 week 120° F. | 12 | 6 | 8.9 | 71 | 0.7 | 96 | 6.7 |
| 10 Day Mech. Stab. | 12 | 6 | 9.0 | 106 | 1.7 | 97 | 5.2 |
| T-681 Initial | 11.8 | 6 | 9.0 | 63 | 0.6 | 96 | 5.4 |
| T-681 2 week AT | 11.8 | 6 | 8.8 | 88 | 0.8 | 97 | 6.2 |
| T-681 4 week AT | coag/floc | | 8.8 | | | | |
| T-681 2 week 120° F. | gel | | | | | | |
| T-681 4 week 120° F. | gel | | | | | | |
| 10 Day Mech. Stab. | coag/floc | | 8.8 | | | | |
| N-100 Initial | 11.5 | 6 | 9.3 | 77 | 0.6 | 96 | 5.7 |
| N-100 2 week AT | coag/floc | | | | | | |
| N-100 4 week AT | coag/floc | | | | | | |
| N-100 2 week 120° F. | gel | | | | | | |
| N-100 4 week 120° F. | gel | | | | | | |
| 10 Day Mech. Stab. | coag/floc | | 9.1 | | | | |
| Exp 106B Initial | 11.7 | 6 | 8.9 | 64 | 0.6 | 96 | 5.7 |
| Exp 106B 2 week AT | 11.7 | 6 | 8.8 | 68 | 0.8 | 96 | 6.3 |
| Exp 106B 4 week AT | 11.8 | 6 | 8.9 | 68 | 0.8 | 96 | 6.2 |
| Exp 106B 2 week 120° F. | 11.7 | 6 | 8.8 | 75 | 0.8 | 96 | 6 |
| Exp 106B 4 week 120° F. | 11.7 | 6 | 8.8 | 78 | 0.7 | 96 | 6.2 |
| 10 Day Mech. Stab. | coag/floc | | | | | | |
| Exp 136A Initial | 11.9 | 6 | 9.0 | 63 | 0.6 | 96 | 6.4 |
| Exp 136A 2 week AT | 11.8 | 6 | 8.9 | 64 | 0.6 | 96 | 6.9 |
| Exp 136A 4 week AT | 11.9 | 6 | 8.9 | 65 | 0.6 | 96 | 6.7 |
| Exp 136A 2 week 120° F. | 11.8 | 6 | 8.8 | 69 | 0.6 | 96 | 6.6 |
| Exp 136A 4 week 120° F. | 11.7 | 6 | 8.8 | 70 | 0.6 | 95 | 6.8 |
| 10 Day Mech. Stab. | 11.9 | 6 | 8.9 | 117 | 1.7 | 98 | 5.4 |
| B75-40 Initial | 11.9 | 6 | 9.0 | 62 | 0.7 | 96 | 6.4 |
| B75-40 2 week AT | 11.8 | 5 | 9.0 | 63 | 0.6 | 96 | 6.7 |
| B75-40 4 week AT | 11.9 | 6 | 8.9 | 65 | 0.7 | 96 | 6.7 |
| B75-40 2 week 120° F. | 11.8 | 6 | 8.9 | 77 | 0.8 | 97 | 6.5 |
| B75-40 4 week 120° F. | 11.9 | 6 | 8.9 | 82 | 0.7 | 96 | 6.6 |
| 10 Day Mech. Stab. | coag/floc | | 8.9 | | | | |
| Alco 177 Initial | 11.9 | 6 | 9.0 | 63 | 0.6 | 96 | 6 |
| Alco 177 2 week AT | 11.9 | 6 | 8.9 | 65 | 0.6 | 97 | 6.3 |
| Alco 177 4 week AT | 12 | 6 | 8.9 | 66 | 0.7 | 97 | 6.4 |
| Alco 177 2 week 120° F. | 11.9 | 6 | 8.8 | 67 | 0.7 | 97 | 6.3 |
| Alco 177 4 week 120° F. | 11.8 | 6 | 8.8 | 68 | 0.7 | 96 | 6.4 |
| 10 Day Mech. Stab. | coag/floc | | 8.9 | | | | |

### Example 8

The samples are from example 6.

ZnO Compatible Dispersant Study
1% Dispersant Actives/Total Pigment Solids
Water Resistance Data

| | WST | WST | TI | TI | QCT | OCT |
|---|---|---|---|---|---|---|
| | 4 Hr FDT | 24 Hr FDT | 4 Hr FDT | 24 Hr FDT | 4 Hr FDT | 24 Hr FDT |
| TAMOL ® 850 | 4D | 4D | 6D | 8MD | 10 | 10 |
| TAMOL ® 681 | 8D | 8D | 10 | 10 | 10 | 10 |
| NOPCOSPERSE ® 100 | 8M | 8M | 10 | 10 | 10 | 10 |
| Exp 106B | 4D | 6D | 8D | 8D | 10 | 10 |
| Exp 136A | 4D | 4D | 10 | 10 | 10 | 10 |
| POLYACRYL ® B75-40K | 4D | 4M | 4D | 6D | 2MD | 2MD |
| ALCOSPERSE ® 177 | 8F | 8F | 6D | 8F | 10 | 10 |

### Example 9

The following samples were prepared using the method of example 1.

Sample 1 53A: 60 parts Sodium Salt of Methacrylic acid and 40 parts 2 phenoxy ethyl acrylate.

Sample 153B: 60 parts Ammonium salt of Methacrylic acid and 40 parts 2 phenoxy ethyl acrylate.

Sample 162A: 60 parts Sodium Salt of Methacrylic acid and 40 parts Phosphated hydroxyethyl acrylic acrylate.

Sample 162B: 60 parts Ammonium salt of Methacrylic acid and 40 parts Phosphated hydroxyethyl acrylic acrylate.

### Example 10

Pigment Dispersion and Paint Preparation

An amount of dispersing polymer solution sufficient to yield 1% polymer solids per total pigment solids in the pigment dispersion was mixed with the following ingredients.

A grind was prepared with the following materials: 85 parts cellulose thickener (QP-4400®, 2.5% solids, Union Carbide Chemicals and Plastics Company, Inc., Danbury, Conn.), 62.5 parts deionized water, 2.5 parts non-ionic surfactant (TRITON® CF-10, Union Carbide Chemicals and Plastics Company, Inc., Danbury, Conn.), 1 part defoamer (NOPCO® NXZ, Cognis Corporation, 10 Ambler, Pa.), 25 parts ethylene glycol, 237.5 parts TiO2 (TIPURE® R-960, DuPont, Wilmington, Del.), 25 parts ZnO, and 212.7 parts talc (NYTAL® 300, R. T. Vanderbilt Company, Inc., Norwalk, Conn.) and the experimental polymer dispersants as shown

| Example # of Dispersant | Parts of | |
|---|---|---|
| Polymer | Dispersant | Description of dispersant polymer |
| (% in water) | polymer added | (% parts monomer) |
| T-850 (30%) | 15.8 | Rohm & Haas, Co., Philadelphia, PA |
| NOPCOSPERSE ® 44¹ | 13.6 | Dispersant polymer, Cognis Corporation, |
| (35%) | | Ambler, PA |
| TAMOL ® 731A¹ (25.0%) | 19.0 | Rohm & Haas, Co., Philadelphia, PA |
| TAMOL ® 165A¹ (21.5%) | 22.1 | Rohm & Haas, Co., Philadelphia, PA |
| 153A (30.0%) | 15.8 | 40 POE/60 MAA Na; Hazy tan liquid |
| 153B (29.8%) | 15.9 | 40 POE/60 MAA NH4; Hazy tan viscous liquid |
| 162A (24.6%) | 19.3 | 40 HEA-PO4/60 MAA Na; Slightly hazy |
| | | pinkish liquid |
| 162B (30.0%) | 15.8 | 40 HEA-PO4/60 MAA NH4; Hazy |
| | | greenish liquid |

¹TAMOL ® 731A and TAMOL ® 165A will be referred to as T-731A and T-165A respectively.
NOPCOSPERSE ® 44 will be referred to as N-44.
MAA Na = Sodium Salt of Methacrylic acid
MAA NH4 = Ammonium Salt of Methacrylic acid
HEA-PO4 = Phosphated hydroxyethyl acrylic acrylate
POE = 2 Phenoxyethylacrylate
MA = Maleic Acid

The mixture was ground for about 20 minutes using a high speed Dispermat CV model D 5226 until it reached a fineness-of-grind of 6+, the following was then added:

Letdown

The Letdown consisted of 421.6 parts acrylic latex binder (RHOPLEX® AC-2388, Rohm & Haas, Philadelphia, Pa.), 1 part defoamer (NOPCO®) NXZ, Cognis Corporation, Ambler, Pa.), 9.3 parts tributyl phosphate, 34 parts propylene glycol, and 65.3 parts ammonia hydroxide (28%).

The pH of the resulting mixture was adjusted to a pH of 9.0 by adding a sufficient amount of 28% aqueous ammonium hydroxide. The test paints were allowed to equilibrate 24 hours prior to testing.

Test paints were applied to aluminum Q-Panels having a mill finish 3003 (0.025″×3″×9″ dimension). Paints were applied 6 mils wet using a wet film applicator. Coated panels were then allowed to air dry horizontally for 24 hours. After 24 hours of film dry time, the panels were placed (coated side facing inside the chamber) on the QCT Weatherometer. This test method is a modified version of ASTM D 4585 with an internal chamber temperature of 100 F. Panels were rated hourly for the first eight hours with the final rating taken at hour 24. ASTM D714 is used to rate both frequency and size of visible blisters. Prior to QCT testing, gloss values were taken using a BYK Gardner Micro TRI glossmeter.

### Example 11

The eight paints of example 10 were measured for their initial physical and application properties. Each sample was then split into two aliquots, one of the aliquots was further split and 10 day mechanical stability testing was conducted. Physical & Application Properties were measured at 2 and 4 week intervals at ambient temperature and were also measured at 2 and 4 week intervals under 120° F. oven aging conditions. The KU (kreb unit to measure intermediate shear viscosity), ICI (high shear viscosity), FOG (fineness of grind measured in units of hegman), pH of the samples were measured before and after the 10 day mechanical stability. Water sensitivity testing on the formulations were done to determine the dried film's sensitivity. The physical properties measured were wt/gal, FOG, pH, KU, ICI. The application properties measured were 85° sheen, C/R is the contrast ratio where 100 means 100% hiding.

ZnO Compatible Dispersant Study
1% Dispersant Actives/Total Pigment Solids
Physical & Application Data

| | wt/gal | FOG | pH | KU | ICI | C/R | 85° Sheen | |
|---|---|---|---|---|---|---|---|---|
| T-850 Initial | 11.8 | 6 | 9.0 | 65 | 0.7 | 96 | 6.9 | |
| T-850 2 week AT | 11.8 | 5 | 9.0 | 70 | 0.7 | 96 | 6.5 | |
| T-850 4 week AT | | | | | | | | |
| T-850 2 week 120° F. | 11.9 | 6 | 8.9 | 72 | 0.8 | 96 | 6.5 | |
| T-850 4 week 120° F. | | | | | | | | |
| 10 Day Mech. Stability | | 6 | 9.0 | 90 | 1.5 | | | Fluid, slight |
| | | | | | | | | pigment |
| | | | | | | | | settle |
| N-44 Initial | 11.7 | 6 | 9.1 | 62 | 0.6 | 97 | 7.3 | |
| N-44 2 week AT | 11.9 | 6 | 9.1 | 63 | 0.6 | 96 | 7.3 | |
| N-44 4 week AT | | | | | | | | |
| N-44 2 week 120° F. | 11.9 | 6 | 9.1 | 64 | 0.8 | 96 | 7.1 | |
| N-44 4 week 120° F. | | | | | | | | |
| 10 Day Mech. Stability | | 6 | 9.1 | 75 | 1.1 | | | Fluid, slight |
| | | | | | | | | pigment |
| | | | | | | | | settle |
| T-731A Initial | 11.6 | 6 | 9.0 | 72 | 0.7 | 97 | 6.8 | |
| T-731A 2 week AT | 11.6 | 6 | 8.9 | 76 | 0.8 | 96 | 6.7 | |
| T-731A 4 week AT | | | | | | | | |
| T-731A 2 week 120° F. | 11.7 | 6 | 8.9 | 83 | 0.7 | 96 | 6.8 | Slight gel |
| | | | | | | | | structure, |
| | | | | | | | | recoverable |
| T-731A 4 week 120° F. | | | | | | | | |
| 10 Day Mech. Stability | | 6 | 8.9 | 62 | 0.7 | | | Fluid |
| T-165A Initial | 10.8 | 6 | 8.9 | 76 | 0.8 | 96 | 5.4 | |
| T-165A 2 week AT | 11.8 | 6 | 8.8 | 82 | 0.8 | 96 | 5.9 | Gel, |
| | | | | | | | | recoverable |
| T-165A 4 week AT | | | | | | | | |
| T-165A 2 week 120° F. | x | x | x | x | x | x | x | Gel, |
| | | | | | | | | coagulated |
| T-165A 4 week 120° F. | x | x | x | x | x | x | x | |
| 10 Day Mech. Stability | | 5 | 8.7 | 73 | 1 | | | Foamy |
| Exp 153A Initial | 11.8 | 6 | 9.0 | 68 | 0.7 | 97 | 6.4 | |
| Exp 153A 2 week AT | 11.9 | 6 | 8.9 | 72 | 0.7 | 96 | 6.4 | |
| Exp 153A 4 week AT | | | | | | | | |
| Exp 153A 2 week | 11.9 | 6 | 8.8 | 79 | 0.8 | 96 | 6.6 | 5% CLS |
| 120° F. | | | | | | | | |
| Exp 153A 4 week | | | | | | | | |
| 120° F. | | | | | | | | |
| 10 Day Mech. Stability | x | x | x | x | x | x | x | Gel, |
| | | | | | | | | coagulated |
| Exp 153B Initial | 11.6 | 6 | 8.9 | 68 | 0.8 | 97 | 5.9 | |
| Exp 153B 2 week AT | 11.6 | 5 | 8.8 | 75 | 0.8 | 96 | 6 | |
| Exp 153B 4 week AT | | | | | | | | |
| Exp 153B 2 week | x | x | 8.7 | x | x | x | x | Gel, |
| 120° F. | | | | | | | | somewhat |
| | | | | | | | | recoverable |
| Exp 153B 4 week | x | x | x | x | x | x | x | Gel, |
| 120° F. | | | | | | | | coagulated |
| 10 Day Mech. Stability | x | x | x | x | x | x | x | Gel, |
| | | | | | | | | coagulated |
| Exp 162A Initial | 11.8 | 6 | 9.1 | 67 | 0.7 | 96 | 6.9 | |
| Exp 162A 2 week AT | 11.8 | 6 | 9.0 | 77 | 0.7 | 96 | 6.8 | |
| Exp 162A 4 week AT | | | | | | | | |
| Exp 162A 2 week | 11.9 | 5 | 9.0 | 76 | 0.8 | 95 | 6.8 | |
| 120° F. | | | | | | | | |
| Exp 162A 4 week | | | | | | | | |
| 120° F. | | | | | | | | |
| 10 Day Mech. Stability | | 6 | 9.0 | 86 | 1.5 | | | Fluid, slight |
| | | | | | | | | pigment |
| | | | | | | | | settle |
| Exp 162B Initial | 11.8 | 6 | 8.9 | 68 | 0.8 | 96 | 6.6 | |
| Exp 162B 2 week AT | 11.9 | 5 | 8.9 | 72 | 0.9 | 96 | 6.6 | |
| Exp 162B 4 week AT | | | | | | | | |
| Exp 162B 2 week | 11.8 | 5 | 8.9 | 77 | 0.9 | 95 | 6.7 | Fluid, slight |
| 120° F. | | | | | | | | pigment |
| | | | | | | | | settle |
| Exp 162B 4 week | | | | | | | | |
| 120° F. | | | | | | | | |
| 10 Day Mech. Stability | x | x | 8.9 | x | x | x | x | Gel, |
| | | | | | | | | coagulated |
| | | | | | | | | (not as bad |
| | | | | | | | | as 153) |

### Example 12

Samples are from example 10.

ZnO Compatible Dispersant Study
1% Dispersant Actives/Total Pigment Solids
Water Resistance Data

| | WST | WST | TI | TI | QCT | QCT |
|---|---|---|---|---|---|---|
| | 4 Hr | 24 Hr | 4 Hr | 24 Hr | 4 Hr | 24 Hr |
| | FDT | FDT | FDT | FDT | FDT | FDT |
| TAMOL ® 850 | 2D | 2D | 8F | 10 | 10 | 10 |
| N-44 | 2D | 2D | 6D | 8D | 4MD | 10 |
| T-731A | 6D | 6D | 10 | 10 | 10 | 10 |
| T-165A | 6D | 10 | 10 | 10 | 10 | 10 |
| Exp 153A | 4M | 6D | 10 | 10 | 10 | 10 |
| Exp 153B | 8M | 8MD | 10 | 10 | 10 | 10 |
| Exp 162A | 2D | 2D | 10 | 10 | 10 | 10 |
| Exp 162B | 2D | 8MD | 8F | 10 | 10 | 10 |

### Example 13

The following samples were prepared using the method of example 1.

Sample 106A: 80 parts Sodium salt of Methacrylic acid and 20 parts 2-Phenoxy ethyl acrylate.

Sample 106B: 80 parts Ammonium salt of Methacrylic acid and 20 parts 2-10 Phenoxy ethyl acrylate.

Sample 112A: 85 parts Sodium salt of Methacrylic acid and 15 parts polyaminomethyl propane sulfonic acid.

Sample 127A: 85 parts Sodium salt of Methacrylic acid and 15 Phosphated hydroxyethyl acrylic acrylate.

Sample 127B: 85 parts Ammonium salt of Methacrylic acid and 15 Phosphated hydroxyethyl acrylic acrylate.

Sample 136A: 92 parts Sodium salt of Methacrylic acid and 8 Vinyl Phosphonate.

### Example 14

Pigment Dispersion and Paint Preparation

An amount of dispersing polymer solution sufficient to yield 1% polymer solids per total pigment solids in the pigment dispersion was mixed with the following ingredients.

A Grind was prepared with the following materials: 255.3 parts deionized water, 12.7 parts ethylene glycol, 4.8 parts thickener (NATROSOL® PLUS, a hydrophobically modified hydroxyethylcellulose, Hercules Inc./Aqualon Div., Wilmington, Del.) and the experimental polymer dispersants as shown:

| Example # of | Parts of | |
|---|---|---|
| Dispersant Polymer | Dispersant | Description of dispersant polymer |
| (% in water) | polymer added | (% parts monomer) |
| T-850 (30%) | 10.8 | Rohm & Haas Co., Philadelphia, PA |
| T-681 (35%) | 9.2 | Rohm & Haas Co., Philadelphia, PA |
| NOPCOSPERSE ® | 11.0 | Registered trademark of Cognis Corporation, |
| 100¹ | | Ambler, PA |
| 106A (30.0%) | 10.8 | 20 POE/80 MAA Na; Hazy, slightly green |
| | | liquid |
| 106B (30.0%) | 10.8 | 20 POE/80 MAA NH4; Hazy dark brown liquid |
| 112A (24.4%) | 13.3 | 15AMPS/85 MAA Na; Clear water white liquid |
| 127A (30.0%) | 10.8 | 15 HEA-PO4/85 MAA Na; Hazy pinkish liquid |
| 127B (30.8%) | 10.5 | 15 HEA-PO4/85 MAA NH4; Hazy green liquid |
| 136A (29.5%) | 11.0 | 8 Vinyl phosphonate/92 MAA Na; Clear water |
| | | white liquid |

¹NOPCOSPERSE ® 100 will be referred to as N-100
BMA = butyl methacrylate
MAA Na = sodium salt of methacrylic acid
MAA NH4 = ammonium salt of methacrylic acid
HEA-PO4 = phosphated hydroxyethyl acrylic acrylate
POE = 2-phenoxyethylacrylate
AMPS = polyaminomethyl propane sulphonic acid

The mixture was mixed for about 5 minutes using a high speed Dispermat CV model D 5226, the following was then added:

Letdown

The Letdown was prepared as follows: 2.7 parts nonyl phenol nonionic surfactant (IGEPAL® CO-630, Rhone-Poulenc, Inc./Surfactants and Speciality Chemicals, Cranberry, N.J.), 1.0 parts preservative/biocide with active ingredients: 5-hydroxymethoxymethyl-1 -aza-3,7-dioxabicyclo(3.3.0)octane,5-hydroxy-methyl-1-aza-3,7-dioxabicyclo-(3.3.0)octane,5-hydroxypoly(methyleneoxy) 74%C2, 21%C3, 4%C4, 1%C5)methyl-1-aza-3,7-dioxabicyclo (3.3.0) octane (NUOSEPT® 95, HULS America, Inc., Piscataway, N.J.), 2.0 parts defoamer (FOAMASTER® S, Cognis Corporation, Ambler, Pa.), 85.1 parts inorganic pigment made of alumina treated TiO2 (TRONOX® CR-800, Kerr-McGee Chemical Corporation, Oklahoma City, Okla.), 102.2 parts Glomax LL, a calcined kaolin clay used as an inorganic pigment filler (a product of Dry Branch Kaolin Co., Dry Branch, Ga.), and 136.2 parts inorganic pigment filler (DURAMITE®, EEC International, Sylacagua, Ala.) which is mostly calcium carbonate were combined using a high speed Dispermat CV model D 5226 for 10 minutes. To this mixture was added 7.6 parts ester alcohol (TEXANOL®, Eastman Co., Kingsport Tenn.), 2.0 parts defoamer (FOAMASTER® SA-3, Cognis Corporation, Ambler, Pa.), 37.5 parts deionized water and 153.2 parts vinyl acrylic latex binder (ROVACE® 9100, Rohm & Haas Co., Philadelphia, Pa.).

The test paints were allowed to equilibrate 24 hours prior to testing.

Test paints were applied to aluminum Q-Panels having a mill finish 3003 (0.025″×3″×9″ dimension). Paints were applied 6 mils wet using a wet film applicator. Coated panels were then allowed to air dry horizontally for 24 hours. After 24 hours of film dry time, the panels were placed (coated side facing inside the chamber) on the QCT Weatherometer. This test method is a modified version of ASTM D 4585 with an internal chamber temperature of 100 F. Panels were rated hourly for the first eight hours with the final rating taken at hour 24. ASTM D714 is used to rate both frequency and size of visible blisters. Prior to QCT testing, gloss values were taken using a BYK Gardner Micro TRI glossmeter.

### Example 15

The nine paints of example 14 were measured for their initial physical and application properties. Each sample was then split into two aliquots, one of the aliquots was further split and 10 day mechanical stability testing was conducted. Physical & Application Properties were measured at 2 and 4 week intervals at ambient temperature and were also measured at 2 and 4 week intervals under 120° F. oven aging conditions. The KU (kreb unit to measure intermediate shear viscosity), ICI (high shear viscosity), FOG (fineness of grind measured in units of hegman), pH of the samples were measured before and after the 10 day mechanical stability. Water sensitivity testing on the formulations done to determine the dried film's sensitivity. The physical properties measured were wt/gal, FOG, pH, KU, ICI. The application properties measured were 85° sheen, C/R is the contrast ratio where 100 means 100% hiding.

Water Resistant, ZnO Compatible Dispersant Program
1% Dispersant Actives/Total Pigment Solids
Physical & Application Data

| | | | | | | 85° | |
|---|---|---|---|---|---|---|---|
| | wt/gal | FOG | pH | KU | ICI | Sheen | C/R |
| T-850 Initial | 11.1 | 6 | 7.9 | 95 | 0.8 | 1.4 | 94.3 |
| T-850 2 wk 120° F. | 11.7 | 6 | 7.3 | 93 | 0.8 | 1.3 | 92.4 |
| T-681 Initial | 11.1 | 6 | 7.8 | 94 | 0.9 | 1.4 | 94.2 |
| T-681 2 wk 120° F. | 11.6 | 6 | 7.2 | 99 | 0.9 | 1.4 | 93.9 |
| N-100 Initial | 11.5 | 6 | 7.6 | 105 | 0.9 | 1.8 | 95.7 |
| N-100 2 wk 120° F. | 11.6 | 6 | 6.9 | 101 | 0.9 | 1.7 | 94.9 |
| 106A Initial | 11.6 | 6 | 7.9 | 99 | 1.0 | 1.4 | 94.3 |
| 106A 2 wk 120° F. | 11.6 | 6 | 7.1 | 99 | 0.9 | 1.3 | 96.7 |
| 106B Initial | 11.1 | 6 | 7.7 | 101 | 1.0 | 1.4 | 95.0 |
| 106B 2 wk 120° F. | 11.6 | 6 | 7.0 | 100 | 0.9 | 1.4 | 94.0 |
| 112A Initial | 11.2 | 6 | 8.0 | 96 | 0.8 | 1.4 | 94.7 |
| 112A 2 wk 120° F. | 11.6 | 6 | 7.1 | 93 | 0.9 | 1.3 | 93.1 |
| 127A Initial | 11.2 | 6 | 8.0 | 97 | 1.1 | 1.4 | 94.6 |
| 127A 2 wk 120° F. | 11.7 | 6 | 7.1 | 94 | 0.8 | 1.3 | 93.6 |
| 127B Initial | 11.2 | 6 | 7.8 | 99 | 0.9 | 1.4 | 94.4 |
| 127B 2 wk 120° F. | 11.7 | 6 | 7.0 | 96 | 0.8 | 1.3 | 93.7 |
| 136A Initial | 11.4 | 6 | 8.0 | 94 | 0.8 | 1.4 | 94.1 |
| 136A 2 wk 120° F. | 11.6 | 6 | 7.1 | 90 | 0.8 | 1.3 | 93.1 |

### Example 16

The samples are from example 14.

Water Resistant, ZnO Compatible Dispersant Program
Water Resistant Screening formula
1% Dispersant Actives/Total Pigment Solids

| | WST | WST | TI | TI | QCT | QCT |
|---|---|---|---|---|---|---|
| | 4 Hr | 24 Hr | 4 Hr | 24 Hr | 4 Hr | 24 Hr |
| | FDT | FDT | FDT | FDT | FDT | FDT |
| TAMOL ® 850 | 2D | 2D | 6D | 6D | 6D | 4D |
| TAMOL ® 681 | 2D | 2D | 8D | 8D | 6D | 8D |
| N-100 | 2D | 8D | 8D | 10 | 10 | 8M |
| 106A | 2D | 2D | 4D | 4D | 6D | 8MD |
| 106B | 2D | 6D | 8D | 10 | 10 | 8MD |
| 112A | 2D | 2D | 4D | 4D | 4D | 10 |
| 127A | 2D | 2D | 4D | 4D | 4D | 6D |
| 127B | 2D | 6D | 8D | 8D | 4D | 4D |
| 136A | 2D | 2D | 6D | 6D | 4D | 10 |

What is claimed is:

1. A water soluble copolymer useful as an inorganic pigment dispersant comprised of a polymerized (1) monomer which is an ethylenically unsaturated organic phosphate or phosphonate and (2) an ethylenically unsaturated carboxylated monomer, wherein the amount of the ethylenically unsaturated carboxylated monomer is sufficient to permit the copolymer to associate with an inorganic pigment in an aqueous medium in a manner which disperses the inorganic pigment in the aqueous medium to form a stable aqueous dispersion of the inorganic pigment.

2. The copolymer of claim 1 wherein the ethylenically unsaturated organic phosphate is a compound of the formula I
R¹OR²OR³O—PO (I)
wherein each of R¹, R², and R³ is independently hydrogen or CH₂═CR⁴—CO—(OX)_{y}— wherein R⁴ is hydrogen or methyl; X is an alkylene group having from 2 to 4 carbon atoms and y is an integer of from 1 to 10 with the proviso that at least one of R¹, R², and R³ is CH₂═CR⁴—CO—(OX)_{y}—.

3. The copolymer of claim 2 wherein the compound of formula 1 is selected from the group consisting of phosphoxyhexa(oxypropylene) mono-, di- and tri-methacrylate, phosphoxydodeca(oxypropylene) mono-, di- and tri-methacrylate, phosphoxyhexa(oxyethylene) mono-, di- and tri-methacrylate, phosphoxydodeca(oxyethylene) mono-, di- and tri-methacrylate, phosphoxyhexa(oxypropylene) mono-, di- and tri-acrylate, phosphoxydodeca(oxypropylene) mono-, di- and tri-acrylate, phosphoxyhexa(oxyethylene) mono-, di- and tri-acrylate and, phosphoxydodeca(oxyethylene) mono-, di- and tri-acrylate.

4. The copolymer of claim 1 further comprising a hydrophobic monomer.

5. The copolymer of claim 4 wherein the hydrophobic monomer is 2-phenoxyethylacrylate or a monovinyl aromatic hydrocarbon having from 8 to 12 carbon atoms and halogenated derivatives thereof having halo-substituted aromatic moieties.

6. The copolymer of claim 5 wherein the hydrophobic monomer is selected from the group consisting of styrene, alpha-methylstyrene, vinyl toluene, meta-methylstyrene, para-methylstyrene, para-ethylstyrene, para-n-propylstyrene, para-isopropylstyrene, para-tert-butylstyrene, ortho-chlorostyrene, para-chlorostyrene, alpha-methyl-meta-methylstyrene, alpha-methyl-para-methylstyrene, tert-butyl styrene, alpha-methyl-ortho-chlorostyrene, and alpha-methyl-para-chlorostyrene.

7. The copolymer of claim 1 wherein the ethylenically unsaturated organic phosphonate is a compound of the formula II
(R⁶O)(R⁷O)R⁵—PO (II)
wherein R⁵ is a vinyl or substituted vinyl and each of R⁶ and R⁷ is independently is hydrogen or C₁₋₁₈ alkyl group with the proviso that at least one of R⁶ or R⁷ is hydrogen.

8. The copolymer of claim 1 wherein the ethylenically unsaturated organic phosphate is phosphated hydroxyethyl acrylate.

9. The copolymer of claim 1 wherein the ethylenically unsaturated carboxylated monomer is methacrylic acid.

10. The copolymer of claim 1 wherein the ethylenically unsaturated organic phosphate is phosphated hydroxyethyl methacrylate.

11. The copolymer of claim 1 wherein the ethylenically unsaturated carboxylated monomer is vinyl phosphonic acid.

12. A water soluble copolymer useful as an inorganic pigment dispersant comprised of a polymerized phosphated hydroxyethyl acrylate and methacyrlic acid.

13. The copolymer of claim 1 wherein the amount of the ethylenically unsaturated organic phosphate or phosphonate is from about 1% to about 60% by weight of the copolymer.

14. The copolymer of claim 1 wherein the amount of the ethylenically unsaturated organic phosphate or phosphonate is from about 10% to about 50% by weight of the copolymer.

15. The copolymer of claim 1 wherein the amount of the ethylenically unsaturated carboxylated monomer is from about 10% to about 50% by weight of the copolymer.

16. The copolymer of claim 1 wherein the amount of the ethylenically unsaturated carboxylated monomer is from about 40% to about 99% by weight of the copolymer.

17. The copolymer of claim 1 wherein the amount of the ethylenically unsaturated carboxylated monomer is from about 50% to about 90% by weight of the copolymer.

18. The copolymer of claim 1 further comprising a hydrophobic monomer which is an ethylenically unsaturated aromatic compound.

19. The copolymer of claim 18 wherein the hydrophobic monomer is selected from the group consisting of styrene, alpha-methylstyrene, vinyl toluene, meta-methylstyrene, para-methylstyrene, para-ethylstyrene, para-n-propylstyrene, para-isopropylstyrene, para-tert-butylstyrene, ortho-chlorostyrene, para-chlorostyrene, alpha-methyl-meta-methylstyrene, alpha-methyl-para-methylstyrene, tert-butyl styrene, alpha-methyl-ortho-chlorostyrene, and alpha-methyl-para-chlorostyrene.

20. The copolymer of claim 1 further comprising a multi-ethylenically unsaturated monomer.

21. The copolymer of claim 20 wherein the multi-ethylenically unsaturated monomer is selected from the group consisting of allyl methacrylate, divinyl benzene, ethylene glycol di-allyl ether, pentaerythritol di-allyl ether, methylene-bis-acrylamide, trimethylene-bis-acrylamide, hexamethylene-bis-acrylamide, N,N′diacryloylpiperazine, m-phenylene-bis-acrylamide, and p-phenylene-bisacrylamide), diethylene glycol diacrylate, propylene glycol dimethacrylate, ethylene glycol dimethacrylate, polyethylene glycol diacrylate, bis(4-acryloxypolyethoxyphenyl)-propane, 1,3-butylene glycol dimethacrylate, 1,5-pentanediol diacrylate, neopentyl glycol diacrylate, 1,6-hexanediol diacrylate, polypropylene glycol diacrylate, pentaerythritol triacrylate, trimethylolpropane triacrylate, trimethylolpropane trimethacrylate, pentaerythritol tetraacrylate, and triethylene glycol trimethacrylate.

22. The copolymer of claim 1 wherein the ethylenically unsaturated organic phosphate is phosphated hydroxyethyl acrylate.

23. The copolymer of claim 1 wherein the ethylenically unsaturated carboxylated monomer is methacrylic acid.

24. The copolymer of claim 1 wherein the ethylenically unsaturated organic phosphonate is vinyl phosphonic acid.

25. A method of preparing an inorganic pigment dispersion comprising dispersing an inorganic pigment in an aqueous medium comprising the copolymer of claim 1.

26. The method of claim 25 wherein the pigment is zinc dioxide.

27. The method of claim 26 wherein the zinc dioxide is dispersed as a 70% aqueous slurry.

28. The method of claim 26 wherein the aqueous medium is comprised of titanium dioxide.

29. A method of preparing an zinc dioxide dispersion which also contains titanium dioxide comprising adding a 70% aqueous zinc oxide dispersion to an aqueous medium comprised of titanium dioxide and a copolymer of claim 1.

30. An aqueous dispersion comprising a pigment and a copolymer of claim 1.

31. The dispersion of claim 30 wherein the pigment is ZnO, TiO2, calcium carbonate, barium sulfate, and zinc phosphate.

32. A latex paint comprising an inorganic pigment in an aqueous medium comprising the copolymer of claim 1.

33. A method of coating a substrate comprising contacting a substrate with a composition comprising a latex paint, a pigment and a copolymer of claim 1 and drying the coated surface to form a film.

34. A composition comprising a substrate, a latex paint, a pigment and a copolymer of claim 1.
